(19) United States
(12) Patent Application Publication
(10) Pub. No.: US 2008/0149773 A1
(43) Pub. Date: Jun. 26, 2008

(54) Method of unloading passengers from a vessel

(76) Inventor: Robert D. Osborne, Bremerton, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/005,537

(22) Filed: Dec. 26, 2007

Related U.S. Application Data
(60) Provisional application No. 60/877,214, filed on Dec. 26, 2006.

(51) Int. Cl. B64D 9/00

(52) U.S. Cl. 244/137.2

(57) ABSTRACT

A method of unloading passengers from a vessel is provided, the vessel having passenger resting positions, an exit, and an aisle. The method includes grouping passengers into a plurality of groups including first, second, and third groups, and instructing the first group of passengers to gather their belongings and enter the aisle while the second and third groups to either remain in their passenger resting positions or out of the aisle. The method further includes instructing the passengers in the first group to exit the vessel. Further, the passengers in the second group are instructed to gather their belongings, enter the aisle, and exit the vessel while the third group of passengers remains in their resting position. Further, the third group of passengers is instructed to gather their belongings, enter the aisle, and exit the vessel. These groupings may be based on location of passengers, their travel status, or other suitable criteria.

### CROSS-REFERENCE TO RELATED APPLICATION

This application claims the benefit under 35 U.S.C. §119(e) of U.S. Provisional Patent Application No. 60/877,214 filed Dec. 26, 2006; where this provisional application is incorporated herein by reference in its entirety.

### BACKGROUND OF THE INVENTION

1. Field of the Invention

The present invention is generally directed to methods of unloading passengers from a vessel, and more particularly, to a method of deplaning passengers from an aircraft.

2. Description of the Related Art

Individuals are increasingly traveling to farther destinations, most of which are impractical to travel to with a private vehicle. Therefore, an expanding community of commuters and travelers use public and commercial transportation such as airplanes, ferries, trains, cruise lines and buses. Most business and leisure travelers increasingly desire to arrive at their destination within the least time possible. Accordingly, the population traveling by airplane continues to increase, despite security concerns of the recent decade. For example, according to the U.S. Department of Transportation's Bureau of Transportation Statistics (BTS) website, http://www.transtats.bts.gov/, U.S. airlines carried about 655 million national passengers in the 12 months ending in September, 2006, and 676 million national passengers in the subsequent 12 months ending in September, 2007; a 3.2 percent increase.

Furthermore, security concerns combined with the large number of people who travel by air has led to processes to expedite the travelers' entire travel experience. In the air travel context, the duration between take off and landing is typically driven by factors such as airplane performance, weather conditions, and passenger and cargo weight. Therefore, this duration is typically fixed with little room left for manipulating the actual travel time.

However, processes for activities preceding take-off and subsequent to landing can be planned to reduce the time passengers spend on each of these activities. Examples of such activities include checking in, boarding, unloading, and claiming baggage.

Numerous processes and/or methods of boarding have emerged including by ascending or descending row number, by boarding pass color, and/or by other priorities such as the age of the traveler and/or whether the traveler is traveling with children. Furthermore, claiming baggage includes processes such as baggage claim tickets bearing a serial number identical to that on the baggage. Baggage claim also includes routing the baggage on a conveyor belt to the baggage claim area simultaneously with when the passengers unload the airplane. However, processes or methods for unloading passengers from a vessel such as an airplane, for example a commercial jet airliner, are generally lacking in the industry.

Typically, as soon as the fasten seatbelt sign is off, most of the passengers attempt to enter the aisle simultaneously and retrieve their belongings to exit the airplane faster. However, in this manner, more people enter the aisle than is efficient for everyone to retrieve their belongings because the aisles become congested and passengers have little space to move, creating a gridlock. At this time, the air-conditioning system is usually shut down and the air inside the airplane is unpleasant to breathe or remain in for a prolonged period; therefore, passengers have an incentive to follow a method of unloading, knowing that if they do, they would all unload the airplane faster than without following the method.

Furthermore, airlines have a strong incentive to unload passengers faster to clean the airplane and reload with waiting passengers. Some airlines, which have tight schedules, will likely be able to reduce the number of airplanes required for daily scheduled flights if there is a reduction of a few minutes from the duration of each unloading and loading cycle. Currently, flights are commonly delayed. Some airlines estimate on-time departure possibility at 50% for certain flights at the time of ticket purchase.

Despite the desire for the method to unload passengers, factors such as increasing airline costs, security expenses, and competition have left little room for airlines to spend money and/or resources on research and development of complicated processes. A practical method of unloading for this industry likely needs to be inexpensive to implement.

### BRIEF SUMMARY

A method is provided for unloading passengers from a vessel having a plurality of passenger resting positions, in which passengers rest while the vessel travels, at least one exit opening, and at least one aisle extending toward the exit opening. Unloading passengers according to embodiments of the present disclosure reduces an average duration for unloading each passenger and also the duration for evacuating the vessel. This also reduces a turn around time for the vessel to begin its journey to its next destination. According to one embodiment, the method includes grouping all passengers with a plurality of groups including first, second, and third groups, or more as needed, and instructing the first group of passengers to gather their belongings and enter the aisle while instructing the at least second group to remain in their passenger resting positions or to stay out of the aisle. In this manner not all passengers enter the aisle simultaneously, which is the case in conventional methods, causing gridlock in the aisle and slowing down the unloading process.

The method further includes instructing the passengers in the first group to advance toward and exit the vessel through the exit opening. Further, the passengers belonging to the second group are instructed to gather their belongings and enter the aisle while those in the third group are instructed to either remain in their passenger resting positions or stay out of the aisle. The second group of passengers is instructed to advance toward and exit the vessel through the exit opening.

In one embodiment, grouping the passengers into the plurality of groups is based on the location of the passengers' resting positions, such as columns or rows, or other location-based criteria. In addition or instead, grouping the passengers into the plurality of groups can be based on a travel status of the passengers, including, but not limited to, passengers having a connecting flight to catch, passengers traveling with children or an elderly companion, passengers having difficult to manage belongings, passengers with their belongings stored remotely with respect to their resting position, and passengers desiring to exit the vessel with a companion. Those passengers that wish to unload the vessel at a later time for purposes such as unloading with a companion belonging to a subsequent group or for having difficult to handle or remotely located luggage, can be unloaded with a subsequent group or after all assigned groups have evacuated the vessel.

In any of the embodiments, instructions given can be provided by one or more attendants, who may use a communicative device. In addition, or instead, the instructions can be provided by a communicative device configured to communicate the instructions to the passengers, such as displays or speakers displaying or broadcasting prerecorded instructions. Furthermore, the vessel can be of any configuration and can have more than one aisle or exit opening.

### BRIEF DESCRIPTION OF THE SEVERAL VIEWS OF THE DRAWING(S)

FIG. 1 is a plan view of a seating map of a passenger compartment of a vessel.

FIG. 2 is a flow chart of a method of unloading passengers from a vessel according to an embodiment of the present invention.

FIG. 3 is the plan view of the seating map of FIG. 1 at a time during a step of the method of FIG. 2.

FIG. 4 is the plan view of the seating map of FIG. 1 at a time during another step of the method of FIG. 2.

FIG. 5 is the plan view of the seating map of FIG. 1 at a time during yet another step of the method of FIG. 2.

FIG. 6 is a flow chart of a method of unloading passengers from a vessel according to another embodiment.

FIG. 7 is a plan view of a seating map of a passenger compartment of another vessel at a time during a step of the method of FIG. 6.

FIG. 8 is the plan view of the seating map of FIG. 7 at a time during another step of the method of FIG. 6.

FIG. 9 is the plan view of the seating map of FIG. 7 at a time during yet another step of the method of FIG. 6.

FIG. 10 is a flow chart of a method of unloading passengers from a vessel according to yet another embodiment.

FIG. 11 is a plan view of a seating map of a passenger compartment of yet another vessel at a time during a step of the method of FIG. 10.

FIG. 12 is the plan view of the seating map of FIG. 11 at a time during another step of the method of FIG. 10.

FIG. 13 is a flow chart of a method of unloading passengers from a vessel according to still another embodiment.

FIG. 14 is a plan view of the seating map of FIG. 1 at a time during a step of the method of FIG. 13.

FIG. 15 is a plan view of the seating map of FIG. 1 at a time during another step of the method of FIG. 13.

FIG. 16 is a plan view of the seating map of FIG. 1 at a time during yet another step of the method of FIG. 13.

FIG. 17 is a flow chart of a method of unloading passengers from a vessel according to a further embodiment.

FIG. 18 is a plan view of the seating map of FIG. 1 at a time during a step of the method of FIG. 17.

FIG. 19 is a plan view of the seating map of FIG. 1 at a time during another step of the method of FIG. 17.

FIG. 20 is a plan view of the seating map of FIG. 1 at a time during yet another step of the method of FIG. 17.

### DETAILED DESCRIPTION

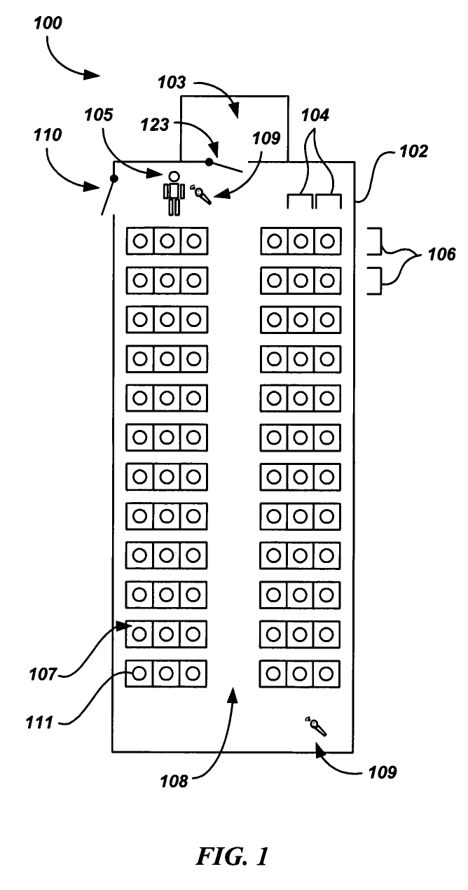

FIGS. 1 and 3-5 are plan views of a seating map 100 for a vessel 102. The vessel 102 may be an aircraft, a train, a bus, watercraft, a mass transit vehicle or any other vessel that carries passengers 111 from a point of departure to their destination. The vessel 102 includes at least one column 104 of passenger resting positions 107, such as seats, standing spaces with poles or handles, or locations at which passengers 111 sit, stand, rest or wait while traveling on the vessel 102 from a time when they board the vessel 102 until they unload from the vessel 102. In the illustrated embodiment of FIG. 1, the vessel 102 includes six columns 104, only two of which are labeled. Additionally, the vessel 102 comprises a plurality of rows 106 of passenger resting positions 107, only two of which are labeled. An aisle 108 is located between two of the columns 104. The vessel 102 further includes an exit opening 110, through which passengers exit the vessel 102. The vessel 102 may also include a crew area 103 having a crew area opening 123, and one or more attendants 105, such as flight attendants.

A communicative device 109, such as a microphone with speakers may also be present on the vessel 102. The communicative device 109 can be any radio, amplifier, sound reproducing or playing device or any combination thereof or any other electronic device operable to convey live or prerecorded instructions. Additionally, or alternatively, the communicative device 109 may include audio and video, such as televisions or other audio-visual device that is installed in the vessel 102 or in a portion of the passenger resting positions 107, such as video screens in a rear portion of seats of an aircraft.

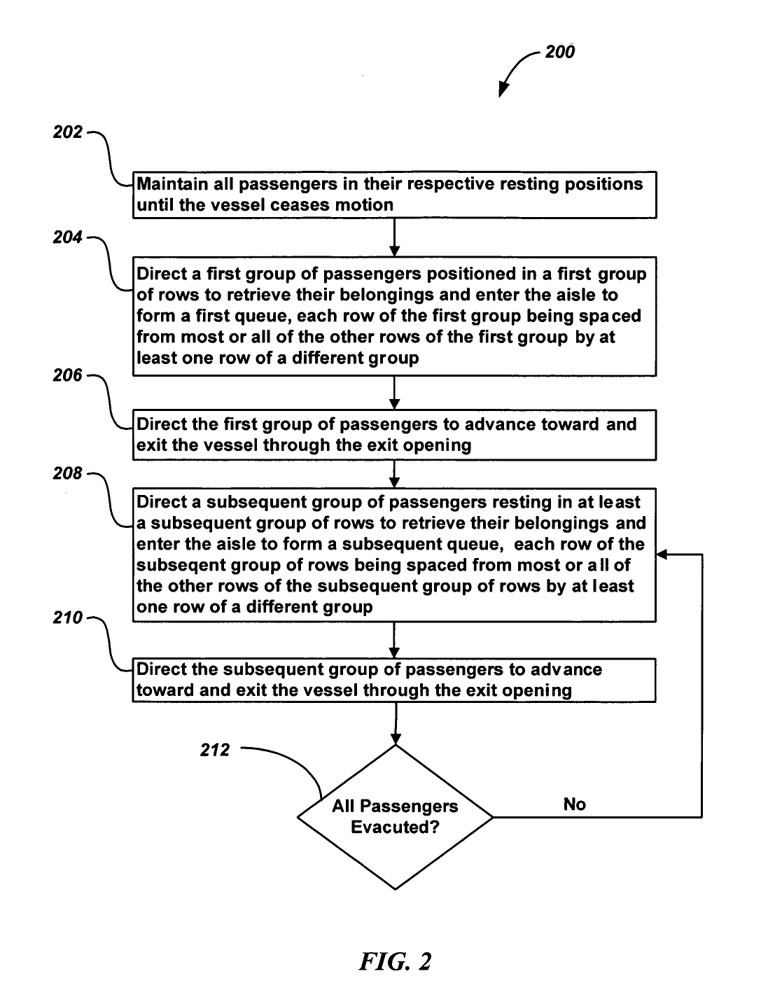

FIG. 2 is a flow chart of a method 200 of unloading passengers from the vessel 102 of FIGS. 1 and 3-5 according to one embodiment. Step 202 is the step as illustrated in FIG. 1, with all passengers 111 in their resting positions 107. In step 202, the attendant 105 uses the communicative device 109 to instruct all passengers 111 to remain in their resting positions 107, for example to remain in their seats, until the vessel 102 reaches its destination and ceases motion.

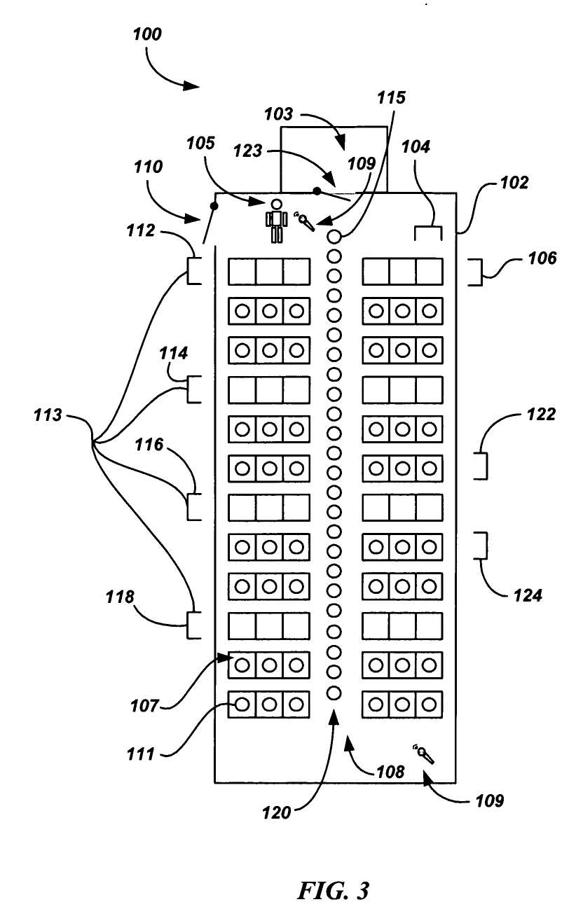

When the vessel 102 ceases motion, the method next proceeds to 204. At step 204, which is as illustrated in FIG. 3, the attendant 105 directs a first group of passengers 115 resting in a first group of rows 113 to retrieve their belongings, enter the aisle 108, and form a first queue 120. This queue 120 is now prepared to clear the aisle 108 and exit the vessel 102. The first group of rows 113 is composed of a plurality of the rows 106 which are spaced from the other rows 106 that are in the first group of rows 113. There are other rows 106 which are in-between the rows selected to be part of the first group of rows 113. For ease of illustration, the rows that are part of the first group of rows 113 are labeled as individual rows 112, 114, 116 and 118 as shown in FIG. 3. The quantity of rows forming the first group of rows 113 is less than the total number of rows 106. Each row 112, 114, 116, 118 of the first group of rows 113 is spaced from other rows 112, 114, 116, 118 of the first group of rows 113 by at least one row 122, or more than one row, for example two rows 122, 124, of a group of rows different from the first group of rows 113. In this manner, passengers 111 forming the first queue 120 are afforded space in the aisle 108 to retrieve their belongings and easily advance toward and exit the vessel 102 through the exit opening 110.

Next, at step 206, the method 200 comprises the attendant 105 directing the first group of passengers 115 to advance toward and exit the vessel 102 through the exit opening 110.

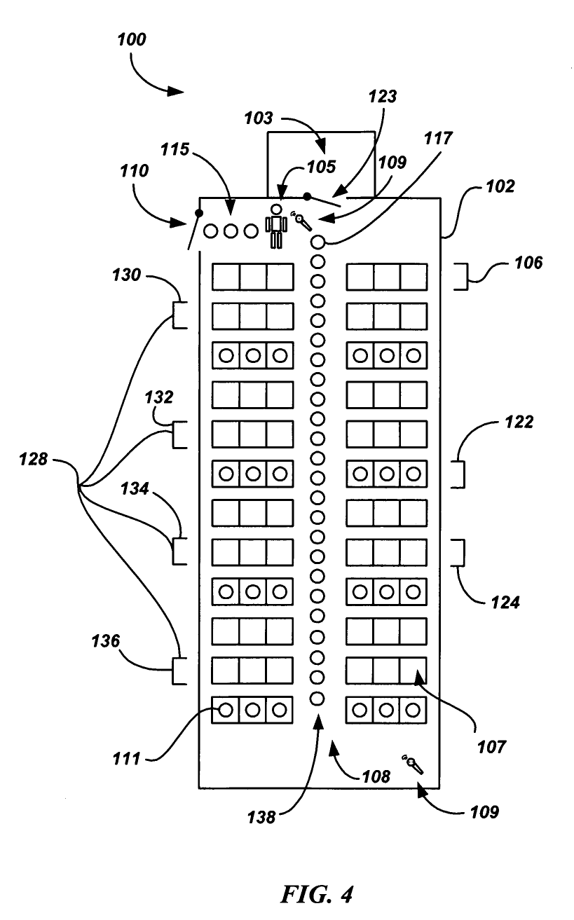

After the first group of passengers 115 has substantially cleared portions of the aisle 108 adjacent respective rows 106, at step 208, which is illustrated in FIG. 4, the method 200 comprises the attendant 105 directing a subsequent group of passengers, in this example a second group of passengers 117 resting in a second group of rows 128, which are labeled as rows 130, 132, 134, 136, to vacate their resting positions 107, retrieve their belongings, enter the aisle 108, and form a second queue 138. The second group of rows 128 is composed of a plurality of the rows 106 which are spaced from the other rows 106 that are in the second group of rows 128. There are other rows 106 which are in-between the rows selected to be part of the second group of rows 128. For example, in the illustrated embodiment of FIG. 4, each row 130, 132, 134, 136 of the second group of rows 128 is spaced apart from other rows 130, 132, 134, 136 of the second group 128 by at least one row 122, or more than one row, for example two rows 122, 124, of a group different from the second group of rows 128. Accordingly, the vessel's passengers 111 will not all simultaneously attempt to exit the vessel 102, allowing space in the aisle 108 for those forming the second queue 138 to retrieve their belongings and easily advance toward and exit the vessel 102 through the exit opening 110.

Next, the method 200 proceeds to 210. At 210, the attendant 105 directs the second group of passengers 117 to advance toward and exit the vessel 102 through the exit opening 110.

After the second group of passengers 117 has substantially cleared portions of the aisle 108 adjacent respective rows 106, at step 212, the method 200 comprises determining whether all passengers 111 have unloaded the vessel 102. If additional passengers are left, the method 200 repeats from 208 onward, with subsequent rows 106 unloading the vessel 102 in sequential groups as described above until the vessel 102 is completely unloaded.

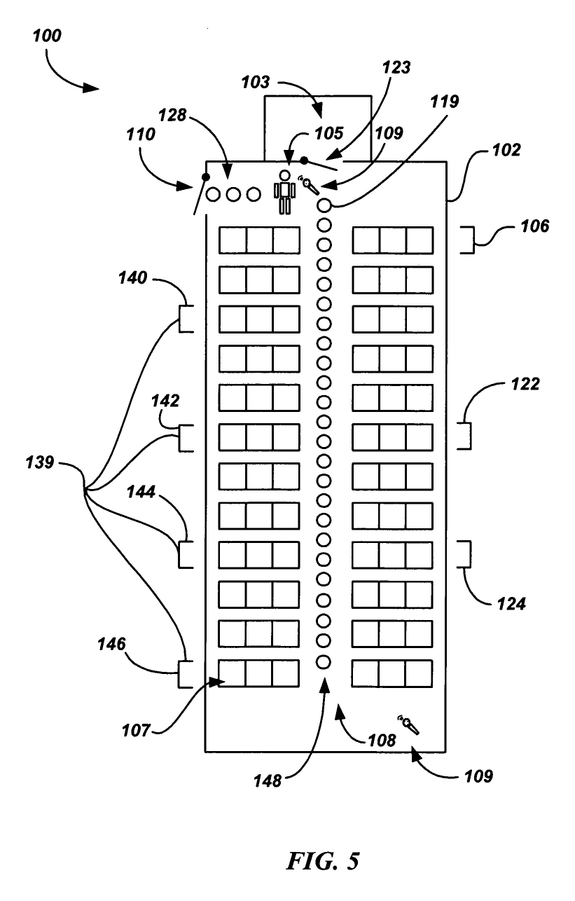

For example, in the illustrated embodiment of FIG. 5 and at a repeated step 208 of FIG. 2, the method 200 comprises the attendant 105 directing a third group of passengers 119 resting in a third group of rows 139, which are labeled rows 140, 142, 144, 146, to vacate their resting positions 107, retrieve their belongings, enter the aisle 108, and form a third queue 148. Again, each row 140, 142, 144, 146 of the third group of rows 139 is spaced apart from other rows 140, 142, 144, 146 of the third group of rows 139 by at least one row 122, or more than one row, for example two rows 122, 124, of a group of rows different from the third group of rows 139. Next, at a repeated step 210, the attendant 105 directs passengers 111 of the final group of rows, the number of which depends on a size and/or configuration of the vessel 102, for example the third group of passengers 119 of the illustrated embodiment of FIG. 4, to advance toward and exit the vessel 102 through the exit opening 110.

Some of the passengers 111 may on occasion experience a longer average wait-time when unloading the vessel 102 according to an embodiment of the present invention, such as the method 200, as compared to the very few passengers that first exit a vessel under the conventional unloading method, which is passenger selected. However, a total duration of time it takes to completely unload the vessel 102 will be substantially reduced if the passengers 111 are unloaded according to the method 200. The method 200 eliminates the time passengers typically expend on struggling to retrieve their bags and/or on maneuvering past each other when airlines or other carriers unload passengers using conventional methods, such as when all passengers attempt to retrieve their belongings simultaneously. This inefficiency is resolved under the method 200 because passengers 111 unload in groups, each group nearly saturating a space available in the aisle 108 for passengers 111 to efficiently retrieve their belongings, easily maneuver with respect to each other, and expeditiously advance toward the exit opening 110.

Additionally, passengers 111 experience an overall reduction in average unloading time per passenger 111 when unloading the vessel 102 according to the method 200. This average unloading time per passenger will likely fall within a consistent duration range depending on a size and configuration of the vessel 102 and the group with which the passengers 111 unload.

It is understood that a method of unloading passengers according to an embodiment of the present invention, such as the method 200, can be applied to any model and/or configuration aircraft or to other types and/or models of vessels.

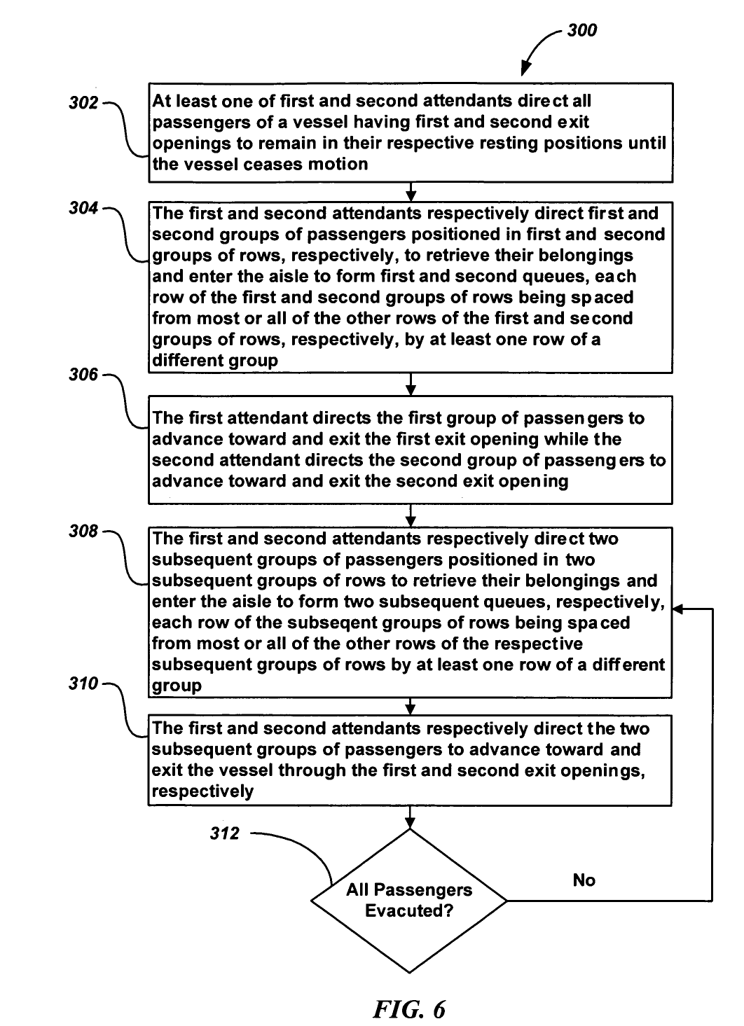

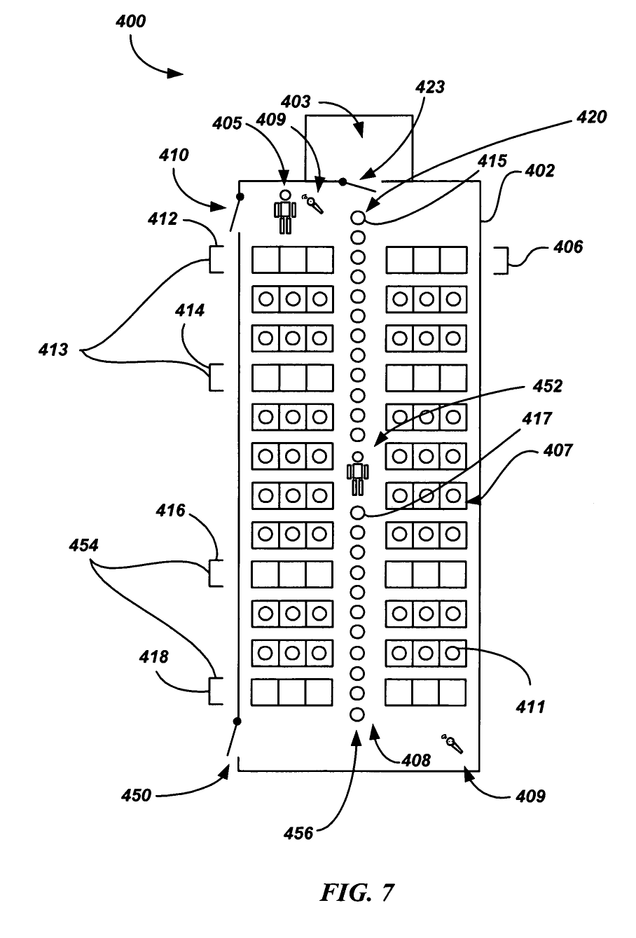

FIG. 6 depicts a flow chart of a method 300 of unloading passengers from a vessel 402 according to another embodiment, in which a vessel 402 comprises more than one exit opening, for example first and second exit openings 410, 450, as illustrated in a seating map 400 of the vessel 402 in FIGS. 7, 8 and 9. The vessel 402 may also include a crew area 403 having a crew area opening 423. Furthermore, more than one attendant 405 can execute the method 300. For example first and second attendants 405, 452 can direct distinct first and second groups of passengers 415, 417 positioned in groups of rows 413, 454. The attendants 405, 452 may use a communicative device 409 to instruct passengers 411. Until the vessel 402 reaches its destination and ceases motion, at step 302, the method 300 comprises the first and/or second attendants 405, 452 directing the first and second groups of passengers 415, 417, respectively, to remain seated.

The first and second groups of rows 413, 454 are composed of a plurality of the rows 406 which are spaced from the other rows 406 that are in the first and second groups of rows 413, 454, respectively. There are other rows 406 which are in-between the rows selected to be part of the first and second groups of rows 413, 454. For ease of illustration, in FIG. 7, the rows that are part of the first group of rows 413 are labeled as individual rows 412 and 414, and the rows that compose the second group of rows 454 are labeled as individual rows 416 and 418.

The method next proceeds to step 304. At step 304 and as illustrated in FIG. 7, the method 300 comprises the first attendant 405 directing the first group of passengers 415 to retrieve their belongings, enter the aisle 408, form a first queue 420, and prepare to exit the vessel 402 through the first exit opening 410. Substantially simultaneously, at step 304, the method 300 comprises the second attendant 452 directing the second group of passengers 417 to retrieve their belongings enter the aisle 408, form a second queue 456, and prepare to exit the vessel 402 through the second exit opening 450.

Next, the method proceeds to step 306. At step 306, the method 300 comprises the first attendant 405 directing the first group of passengers 415 to advance toward and exit the vessel 402 through the first exit opening 410. Substantially simultaneously, at step 306, the method 300 comprises the second attendant 452 directing the second group of passengers 417 to advance toward and exit the aircraft 402 through the second exit opening 450.

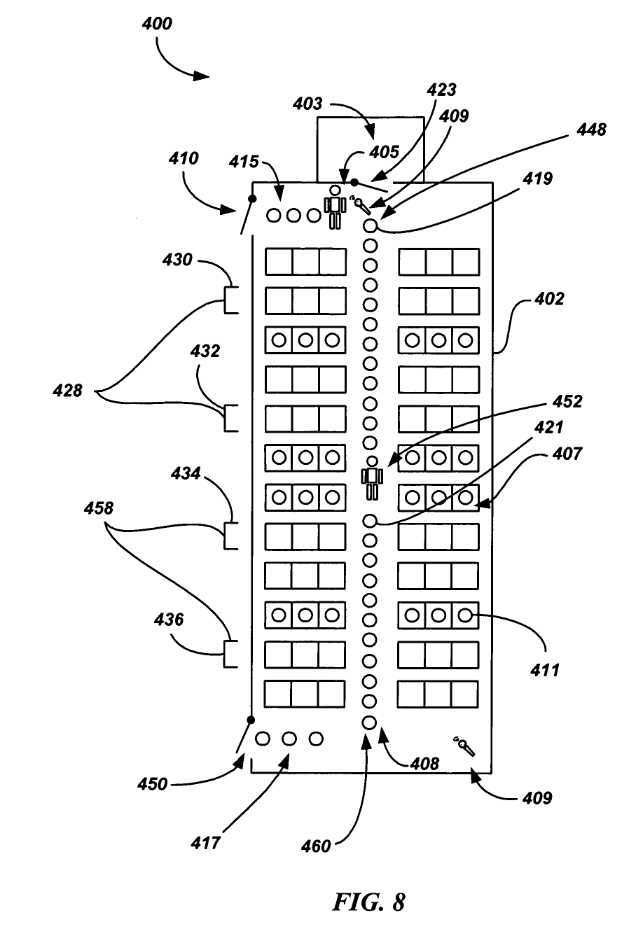

After the first and second groups of passengers 415, 417 substantially exit the aircraft 402, at step 308 and as illustrated in FIG. 8, the method 300 comprises the first and second attendants 405, 452 instructing subsequent groups, in this example third and fourth groups of passengers 419, 421, positioned in third and fourth groups of rows 428, 458, respectively, to vacate their resting positions 407, retrieve their belongings, enter the aisle 408, and form third and fourth queues 448, 460.

The third and fourth groups of rows 428, 458 are composed of a plurality of the rows 406, which are spaced from the other rows 406 that are in the third and fourth groups of rows 428, 458, respectively. There are other rows 406 which are in-between the rows selected to be part of the third and fourth groups of rows 428, 458. For ease of illustration, in FIG. 8, the rows that are part of the third group of rows 428 are labeled as individual rows 430 and 432, and the rows that are part of the fourth group of rows 458 are labeled as individual rows 434 and 436.

The method 300 next proceeds to 310. At step 310, the method 300 comprises the first and second attendants 405, 452 directing the third and fourth groups of passengers 419, 421 to advance toward and exit the vessel 402 through the first and second exit openings 410, 450, respectively.

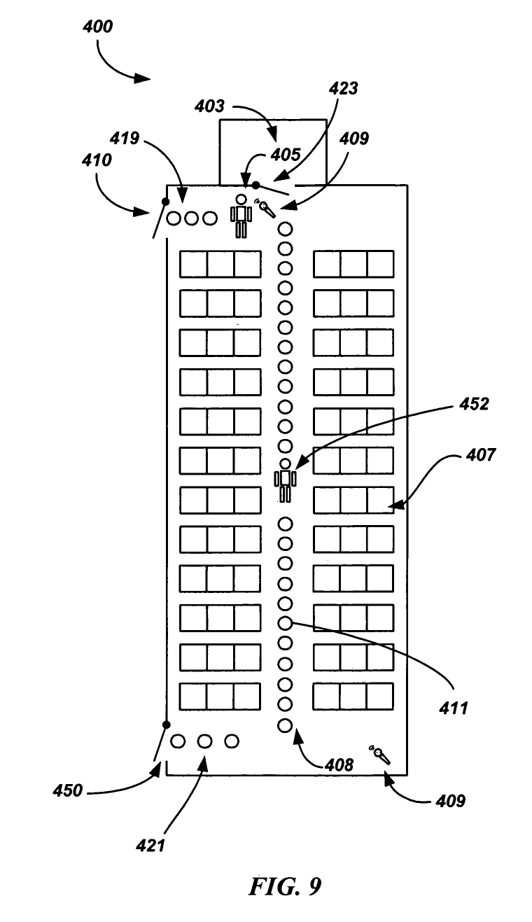

As illustrated in FIG. 9, after the third and fourth groups of passengers 419, 421 substantially exit the vessel 402, subsequent rows unload from the aircraft 402 in sequential groups as described above until all passengers 411 vacate their resting positions 407 and advance toward the respective exit openings 410, 450 to evacuate the vessel 402. The method 300 repeats from 308 onward until all passengers 411 have evacuated the vessel 402.

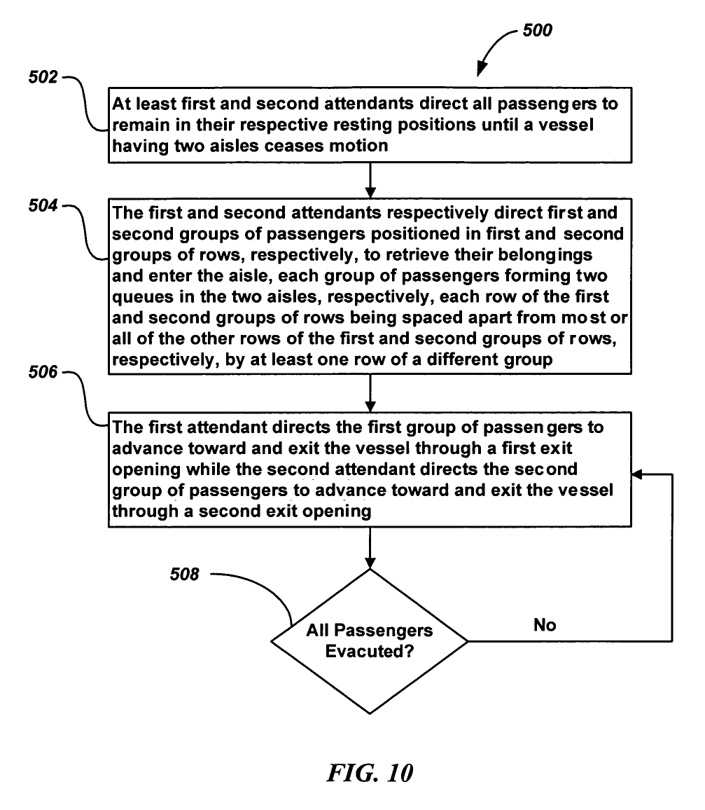

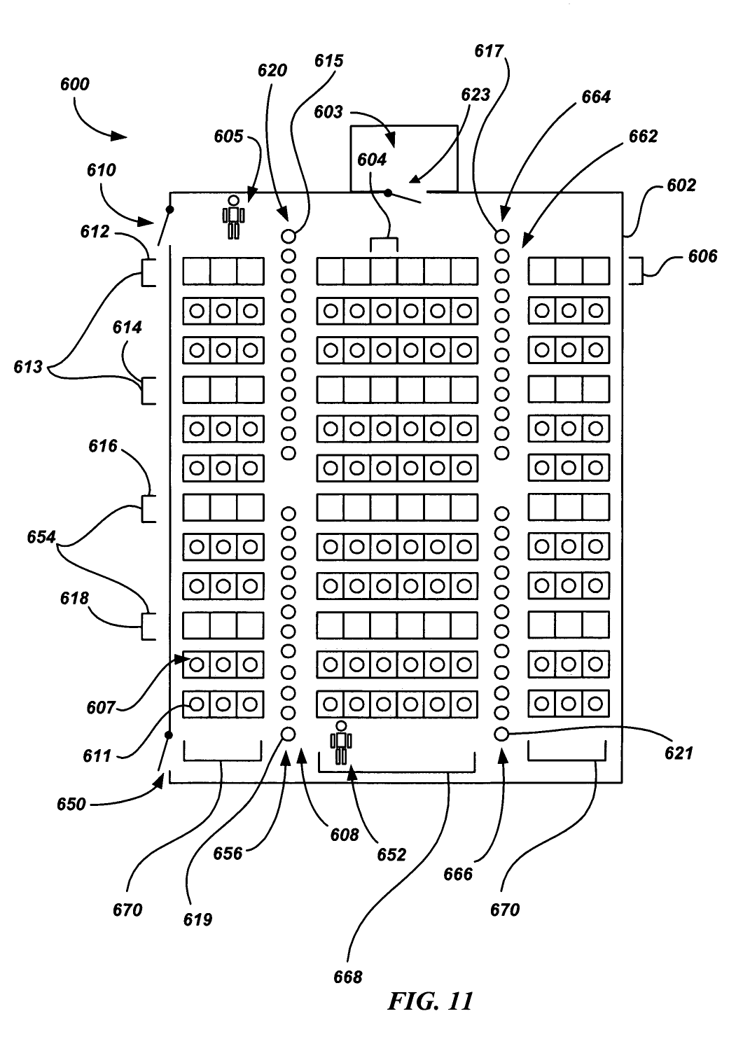

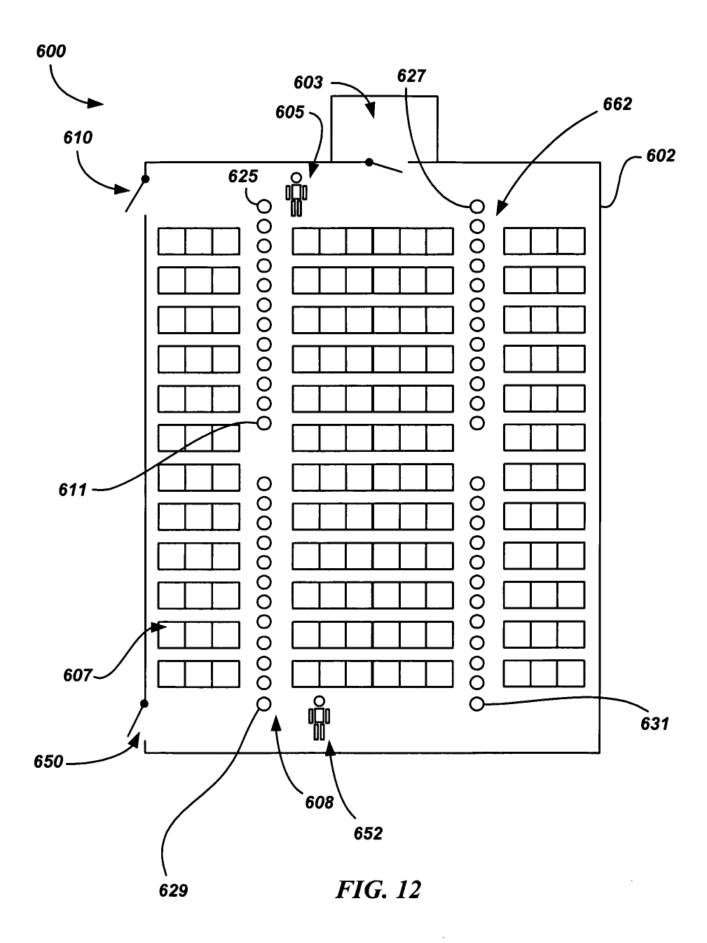

FIG. 10 depicts a flow chart of a method 500 of unloading passengers 611 from a vessel 602 according to another embodiment, in which the vessel 602 comprises more than one exit opening and more than one aisle, for example first and second exit openings 610, 650 and first and second aisles 608, 662 as illustrated in a seating map 600 of the vessel 602 in FIGS. 11 and 12. The vessel 602 may also include a crew area 603 having a crew area opening 623.

Furthermore, at least one attendant 605 can execute the method 500. In the illustrated embodiment of FIGS. 11 and 12, first and second attendants 605, 652 execute the method 500; however, one of ordinary skill in the art will appreciate that more or less attendants can execute the method 500.

At step 502, the method 500 comprises the first and/or second attendants 605, 652 directing first, second, third and fourth groups of passengers 615, 617, 619, 621 positioned and/or resting in first and second groups of rows 613, 654, respectively, to remain in their passenger resting positions 607 until the vessel 602 reaches its destination and ceases motion. The first and second groups of rows 613, 654 are composed of two or more of the rows 606 which are spaced from the other rows 606 that are in the first and second groups of rows 613, 654, respectively, by at least one row of a different group of rows. In the illustrated embodiment of FIGS. 11 and 12, the first group of rows 613 includes rows labeled 612 and 614 and the second group of rows 654 includes rows labeled 616 and 618.

The method next proceeds to step 504. At step 504 and as illustrated in FIG. 11, the method 500 comprises the first attendant 605 directing the first and second groups of passengers 615, 617 to retrieve their belongings, enter the aisles 608, 662, form first and second queues 620, 664, respectively, and prepare to exit the vessel 602 through the first exit opening 610. Substantially simultaneously, at step 504, the method 500 comprises the second attendant 652 directing the third and fourth groups of passengers 619, 621 to retrieve their belongings, enter the aisles 608, 662, form third and fourth queues 656, 666 and prepare to exit the vessel 602 through the second exit opening 650.

Since, the vessel 602 includes two aisles 608, 662, each row 606 includes a center section 668 laterally interposed between the two aisles 608, 662, which in turn are respectively interposed between the center section 668 and one of two opposing lateral sections 670, each of the sections 668, 670 having a plurality of passenger resting positions 607. Therefore, the first group of passengers 615 can include the passengers 611 resting in one of the lateral sections 670 and a portion of the center section 668, proximate the first aisle 608. The second group of passengers can include the passengers 611 resting in the opposing lateral section 670 and a remaining portion of the center section 668, proximate the second aisle 662. Similarly, the third group of passengers 619 can include the passengers 611 resting in one of the lateral section 670 and a portion of the center section 668, proximate the first aisle 608. The fourth group of passengers can include the passengers 611 resting the opposing lateral section 670 and a remaining portion of the center section 668, proximate the second aisle 662. In this manner, overcrowding one of the aisles 608, 662 is prevented.

Next, at step 506, the method 500 comprises the first attendant 605 directing the first and second groups of passengers 615, 617 to advance toward and exit the vessel 602 through the first exit opening 610. Substantially simultaneously, at step 506, the method 500 comprises the second attendant 652 directing the third and fourth groups of passengers 619, 621 to advance toward and exit the vessel 602 through the second exit opening 650.

As illustrated in FIG. 12, subsequent groups of passengers 625, 627, 629, 631 unload from the vessel 602 in sequential groups as described above until all passengers 611 evacuate the vessel 602.

Although the above embodiments discuss examples of a method of unloading passengers from a vessel in context of grouping passengers by rows, one of ordinary skill in the art will appreciate that a method according to another embodiment of the present invention may include grouping passengers by the columns of passenger resting positions.

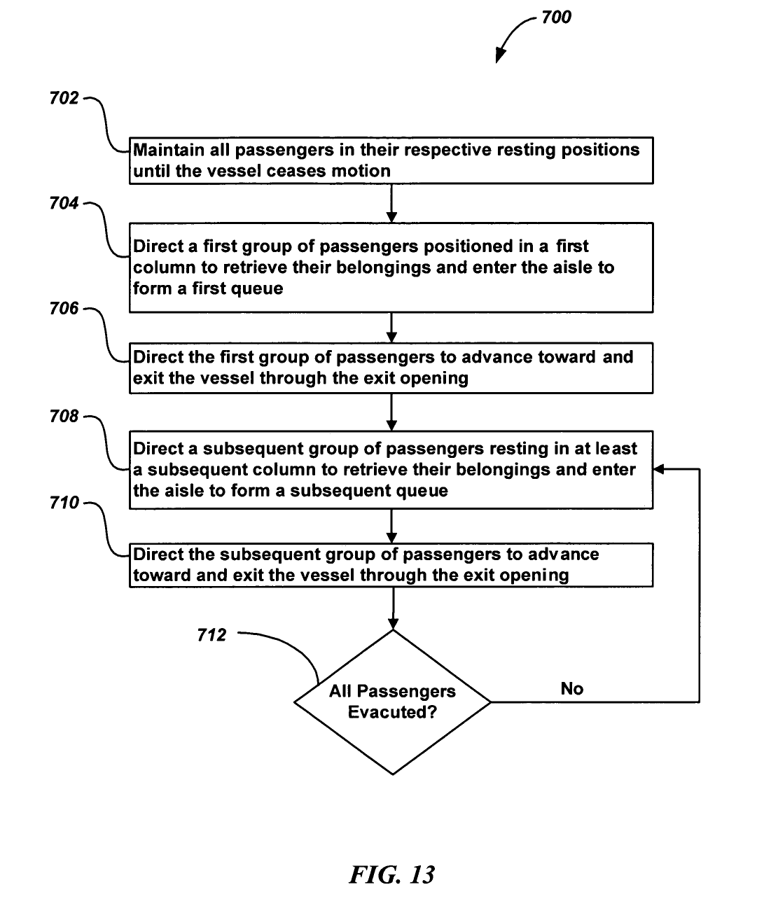

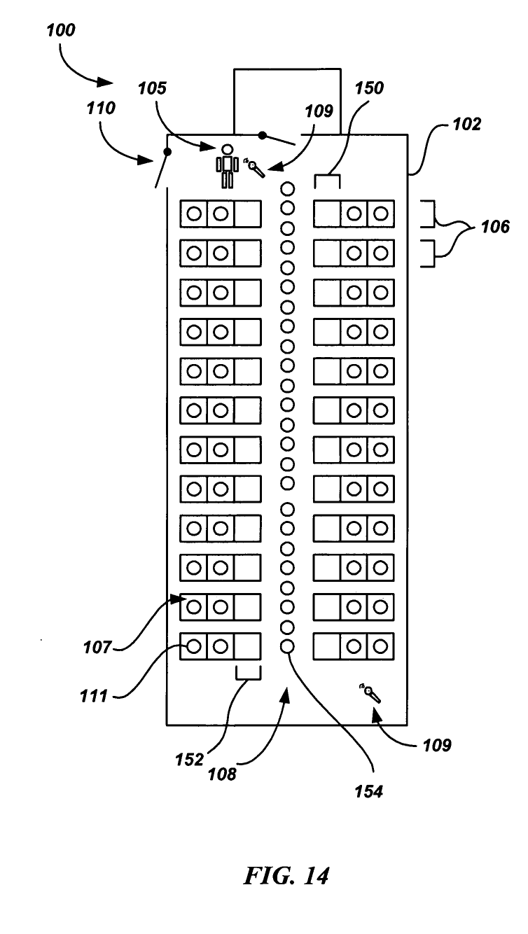

FIG. 13 is a flow chart of a method 700 of unloading passengers from a vessel such as the vessel 102 of FIG. 1. At step 702, the method 700 includes instructing all passengers to remain in their respective resting positions 107. Next, the passengers 111 can be grouped by columns 104 (FIG. 1). For example, as illustrated in FIG. 14, a first group of passengers includes passengers 111 seated in first and second aisle columns 150, 152 positioned on opposing lateral ends of and immediately adjacent the aisle 108. At step 704, and as illustrated in FIG. 14, the method 700 includes instructing the first group of passengers positioned in the first and second columns 150, 152 to retrieve their belongings and enter the aisle 108 to form a first queue 154.

At step 706, the method 700 includes instructing the first group of passengers 111 waiting in the first queue 154 to advance toward and exit the vessel 102 through the exit opening 110.

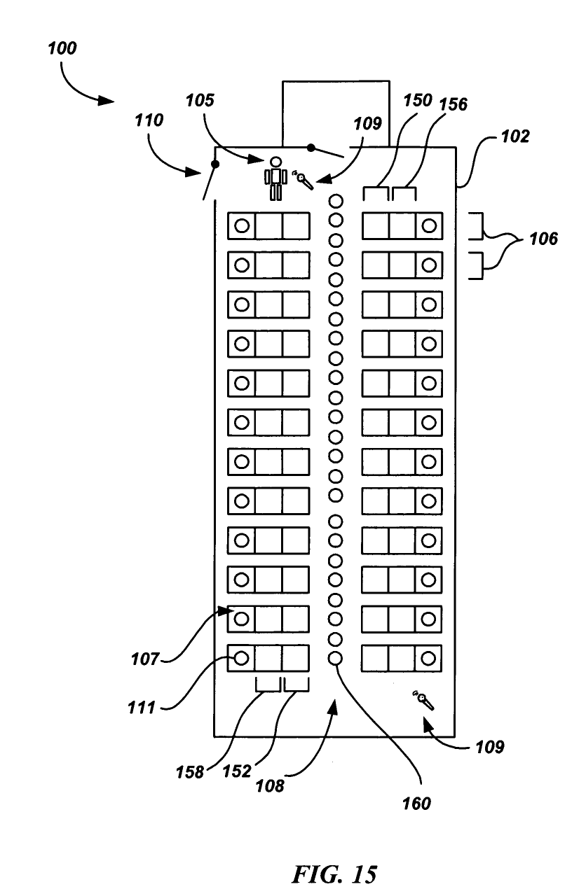

In one aspect, as illustrated in FIG. 15, a second group of passengers includes passengers 111 seated in first and second center columns 156, 158, positioned immediately adjacent the first and second aisle columns 150, 152, respectively. At step 708, the method 700 includes instructing the second group of passengers positioned in the first and second center columns 156, 158 to retrieve their belongings and enter the aisle 108 to form a second queue 160. At step 710, the method 700 includes instructing the second group of passengers 111 waiting in the second queue 160 to advance toward and exit the vessel 102 through the exit opening 110. If at step 712 it is determined that further passengers need to be evacuated, then at repeated steps 708 and 710, subsequent groups of passengers 111, associated with the column in which they are seated, are similarly unloaded until the vessel 102 is evacuated.

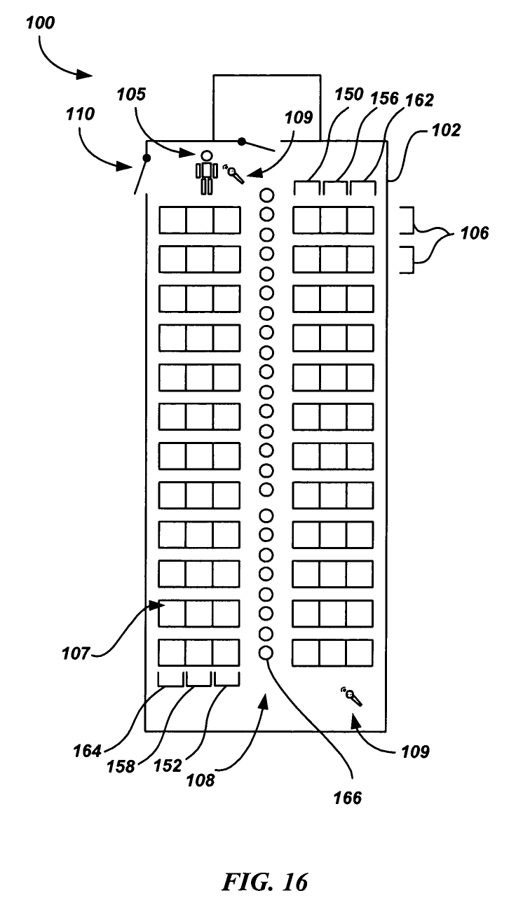

For example, in this embodiment, as illustrated in FIG. 16, a third group of passengers includes passengers 111 seated in first and second side columns 162, 164, positioned immediately adjacent the first and second center columns 156, 158, and interposed between the first and second center columns 156, 158, and opposing lateral ends of the vessel 102, respectively. At repeated step 708, the method 700 includes instructing the third group of passengers positioned in the first and second side columns 162, 164 to retrieve their belongings and enter the aisle 108 to form a third queue 166. At repeated step 710, the method 700 includes instructing the second group of passengers 111 (FIG. 14) waiting in the third queue 166 to advance toward and exit the vessel 102 through the exit opening 110. As in all embodiments, instructions can be given by an attendant 105 or a communicative device 109 configured to broadcast, display, or otherwise communicate the instructions to the passengers 111.

Furthermore, in any of the embodiments above, a method of unloading passengers from a vessel may further comprise forming a last group of passengers, which is composed of passengers positioned in a row, the passengers of which belong to a preceding group of passengers different from the last group of passengers; however, belongings of the passengers in the last group are stored in a location between their resting position and an exit opening from which these passengers would exit if they were to evacuate with the preceding group of passengers. For example, in the air travel context, passengers arriving and boarding late often confront limited storage space for storing their carry-on luggage because the aircraft is typically nearly full by the time the late passengers arrive. Consequently, an attendant or the late passengers store the late passengers' luggage in a storage space found anywhere on the aircraft, even if it is not proximate the late passengers' seats. Therefore, if these passengers were to exit with the respective preceding groups of passengers, the late passengers would delay the evacuation of the preceding groups while attempting to retrieve their belongings, thus impeding the progress of unloading the passengers.

Accordingly, after all passengers properly belonging to preceding groups of passengers evacuate the vessel 102, the attendant instructs the last group to retrieve their belongings, enter the aisle 108, form a queue, prepare to exit the vessel 102, and advance toward and exit from the exit opening 110, in a similar fashion to the embodiments discussed herein. In one embodiment, in order for the passengers to qualify to exit the vessel with the preceding group of passengers, the passengers need to have their belongings positioned and/or stored between from two rows spaced from the passengers in a direction opposing a direction toward the exit opening from which the respective preceding groups of passengers exit.

Accordingly, the passengers belonging to the last group of passengers would include passengers with their belongings stored in a position longitudinally spaced more than one row from them in the direction opposing the direction toward the exit opening. For example, if the exit opening is positioned forward of an airline passenger and that airline passenger has belongings longitudinally positioned more than two rows toward a rear of the airplane, the airline passenger belongs to the last group. In other embodiments, the threshold row of passengers for determining to which group the passengers belong can be the respective passengers' rows. For example, passengers with belongings positioned between their row and the rear portion of the airplane belong to the last group of passengers when the exit opening is toward a forward portion of the airplane.

In still other embodiments, each group of rows may include multiple consecutive rows being spaced from other multiple consecutive rows by at least one row of a different group, rather than each row being spaced from other rows of the respective group of rows.

Although the embodiments described above specify association of passengers to groups based on specific criteria, such as rows or columns, one of ordinary skill in the art will appreciate that passenger grouping in other embodiments can be based on any criteria that may facilitate practical implementation of a method according to an embodiment of the present invention. Different situations or vessels may call for other criteria to be applied when associating passengers with groups, which are contemplated to be within the scope of the present disclosure and the following claims. The above embodiments merely provide examples for a reader to provide a thorough understanding of certain embodiments.

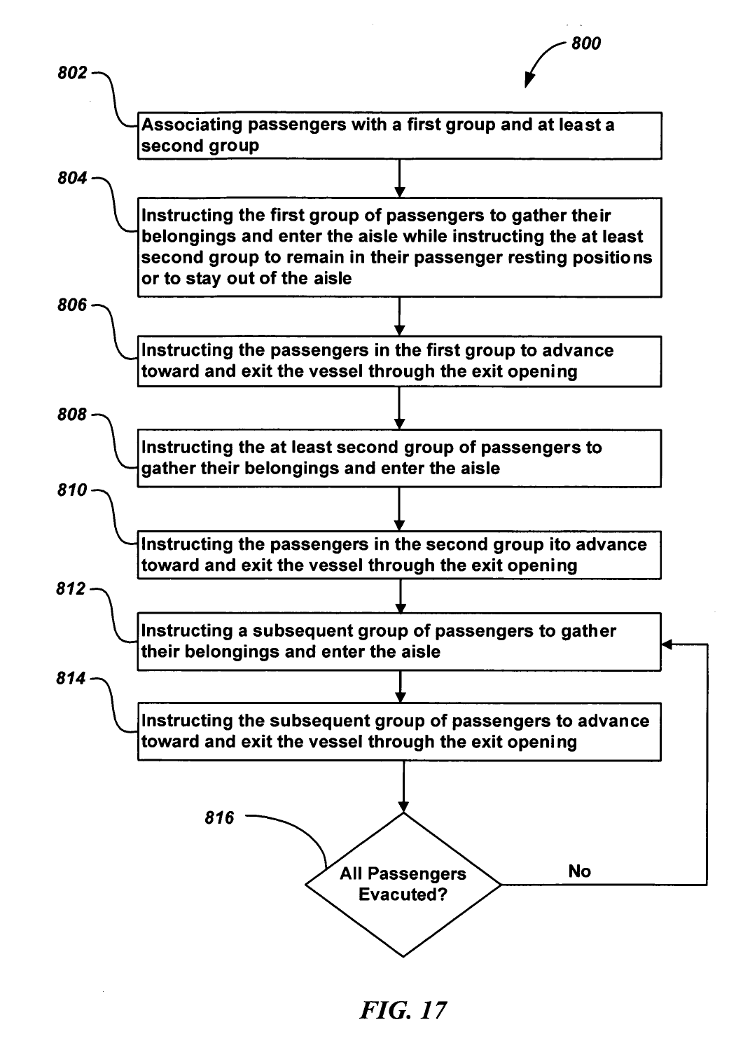

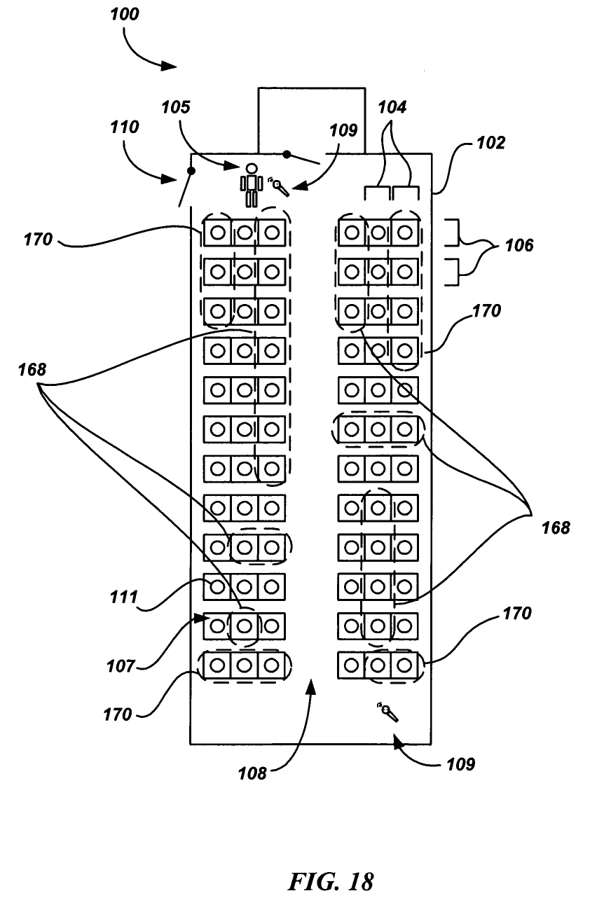

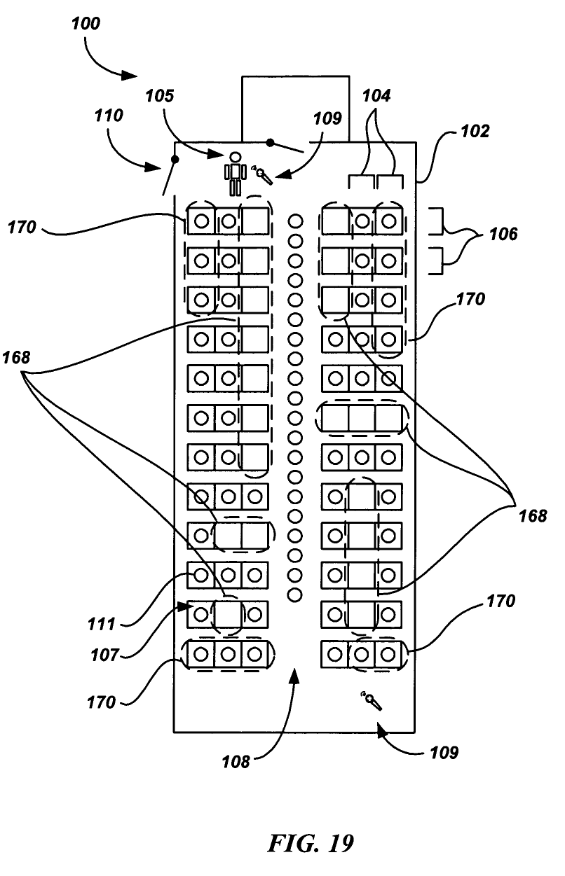

For example, FIG. 17 is a flowchart of a method 800 of unloading passengers from a vessel such as the vessel 102 of FIG. 1, according to another embodiment. At step 802, and as illustrated in FIG. 18, the method 800 includes grouping the passengers 111 into a plurality of groups. For example, the method 800 includes grouping the passengers positioned in a first set of passenger resting positions 168 into a first group and those seating in second set of passenger resting positions 170 into a second group. At step 804, and as illustrated in FIG. 19, passengers 111 of the first group are instructed to gather their belongings and enter the aisle 108 while the passengers 111 of second group are instructed to remain in their passenger resting positions 107 or to stay out of the aisle 108. At step 806, the passengers 111 belonging to the first group are instructed to advance toward and exit the vessel 102 through the exit opening 110.

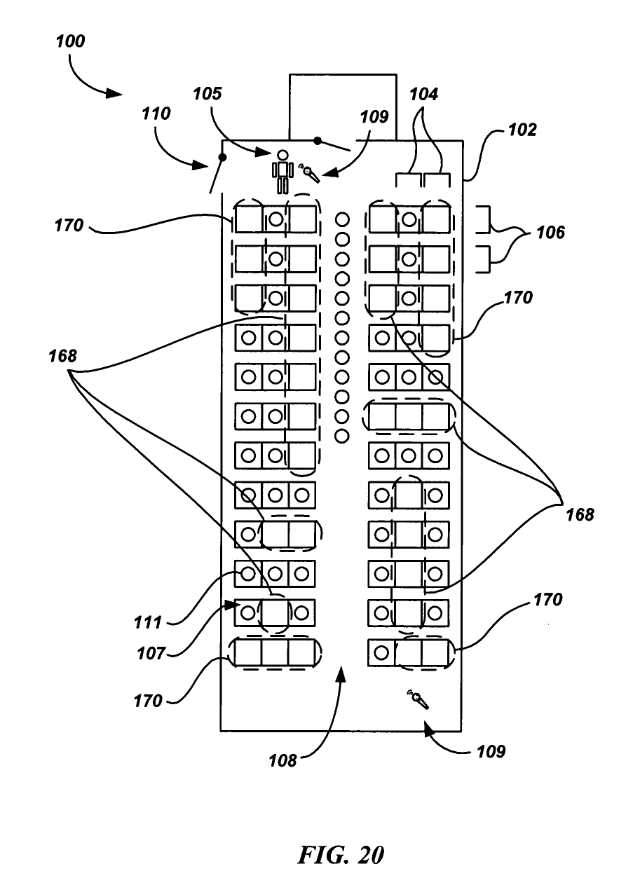

At step 808, and as illustrated in FIG. 20, the passengers 111 belonging to the second group are instructed to gather their belongings and enter the aisle 108. At step 810, the passengers 111 belonging to the second group are instructed to advance toward and exit the vessel 102 through the exit opening 110. At steps 812 and 814, any remaining groups of passengers 112 are evacuated in a substantially identical manner as in steps 808 and 810. At step 816, if any passengers 111 are remaining, steps 812 and 814 are repeated until the vessel 102 is evacuated.

The passengers 111 need not necessarily be seated or positioned in the same column 104 or row 106. Rather, they can be associated to their respective group by any suitable criteria, such based on the location of the passengers' resting positions 107 other than rows or columns. Furthermore, the passengers 111 can be associated with their respective groups based on a travel status of the passengers 111, such as, passengers 111 having a connecting flight to catch, passengers 111 traveling with children or an elderly companion, passengers 111 having difficult to manage belongings, and passengers 111 desiring to exit the vessel 102 with a companion.

Furthermore, instructing the respective groups to gather their belongings and enter the aisle may include instructing the passengers 111 to remain in their passenger resting positions and not enter the aisle with their associated group if they desire to exit the vessel 102 at a time subsequent to a time during which their associated group enters the aisle and exits the vessel 102 or at a time after all the groups have exited the vessel 102. Furthermore, instructing respective groups to gather their belongings and enter the aisle may include instructing the passengers 111 in the first and second groups, respectively, to remain in their passenger resting position and not enter the aisle with their associated group if they desire to exit the vessel 102 with a companion who is associated with a different group, and to gather their belongings and enter the aisle with their companion when the different group is instructed to gather their belongings and enter the aisle or after all groups have exited the vessel 102.

In this embodiment, the method 800 is discussed with respect to the first and second group for clarity of description and illustration. However, one of ordinary skill in the art will appreciate that the plurality of groups can include a third group, a fourth group, or additional groups as needed or as may be practical given specific circumstance or a configuration of the vessel. Furthermore, the methods discussed herein are in conjunction with certain vessel configurations that are provided as examples to provide a thorough understanding of the methods; however, one of ordinary skill in the art will appreciate that these methods can be applied to any configuration vessel, which may include a greater number of aisles or exits, or differently arranged seating or resting position configuration.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the, same embodiment. Furthermore, the particular features, structures, or characteristics may be combined in any suitable manner in one or more embodiments.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and equivalents thereof.

1. A method of unloading passengers from a vessel having at least one column of passenger resting positions and a plurality of rows of passenger resting positions, in which passengers rest while the vessel travels, at least one exit opening, and at least one aisle extending adjacent the plurality of rows to the exit opening, the method comprising:
maintaining all passengers in their respective resting positions until the vessel ceases motion;
directing a first group of passengers resting in a first group of rows to enter the aisle and form a first queue prepared to advance toward the exit opening, each row of the first group of rows being spaced apart from the other rows of the first group of rows by at least one row of a group of rows different from the first group of rows;
directing the passengers in the first queue to advance toward and exit the vessel through the exit opening;
directing at least a second group of passengers resting in at least a second group of rows to enter the aisle and form a second queue, each row of the second group of rows being spaced apart from the other rows of the second group of rows by at least one row of a group of rows different from the second group of rows; and
directing the passengers in the second queue to advance toward and exit the vessel through the exit opening.

2. The method of claim 1 wherein subsequent groups of passengers resting in subsequent groups of rows are directed to enter the aisle and advance toward the exit opening after a preceding group of passengers vacate a portion of the aisle adjacent the subsequent groups of rows.

3. The method of claim 1 wherein the vessel is an aircraft and at least one flight attendant directs the first and at least second groups of passengers.

4. The method of claim 1 wherein the vessel is an aircraft and directing the first and at least second groups of passengers further comprises using at least one communicative device.

5. The method of claim 1 wherein the vessel comprises more than one column of passenger resting positions and the at least one aisle is interposed between two columns.

6. The method of claim 1 wherein the vessel includes at least first and second exit openings, and the passengers in the first queue are instructed to advance toward and exit the vessel through the first exit opening, and substantially simultaneously, the passengers in the second queue are instructed to advance toward and exit the vessel through the second exit opening.

7. The method of claim 6, further comprising:
directing at least a third group of passengers resting in at least a third group of rows to enter the aisle and form a third queue prepared to advance toward the first exit opening, each row of the third group of rows being spaced apart from the other rows of the third group of rows by at least one row of a group of rows different from the third group of rows;
directing at least a fourth group of passengers resting in at least a fourth group of rows to enter the aisle and form a fourth queue prepared to advance toward the second exit opening, each row of the fourth group of rows being spaced apart from the other rows of the fourth group of rows by at least one row of a group of rows different from the fourth group of rows; and
directing the passengers in the third queue to advance toward and exit the vessel through the first exit opening, and substantially simultaneously, directing the passengers in the fourth queue to advance toward and exit the vessel through the second exit opening.

8. The method of claim 7 wherein a first attendant directs the first and at least third groups of passengers, and a second attendant directs the second and at least fourth groups of passengers.

9. The method of claim 7, further comprising:
directing each group of passengers to retrieve their belongings before or during entering the aisle.

10. A method of unloading passengers from a vessel having a center section interposed between first and second aisles, each aisle interposed between the center section and one of first and second opposing lateral sections, respectively, and first and second exit openings respectively positioned toward opposing longitudinal ends of the vessel, the center and lateral sections including a plurality of columns and rows of passenger resting positions, the method comprising:
at least one of first and second attendants directing all passengers to remain in their respective resting positions until the vessel ceases motion;
the first attendant directing a first group of passengers seated in a first group of rows in the passenger resting positions located in the first lateral section and a portion of the center section proximate the first aisle, to enter the first aisle and form a first queue;
the first attendant, substantially simultaneously, directing a second group of passengers seated in the first group of rows in the passenger resting positions located in the second lateral section and a remaining portion of the center section proximate the second aisle, to enter the second aisle and form a second queue;
the second attendant directing a third group of passengers seated in a second group of rows in the passenger resting positions located in the first lateral section and a portion of the center section proximate the first aisle, to enter the first aisle and form a third queue;
the second attendant, substantially simultaneously, directing a fourth group of passengers seated in the second group of rows in resting positions located in the second lateral section and a remaining portion of the center section proximate the second aisle, to enter the second aisle and form a fourth queue;
the first attendant directing the first and second queues to advance toward and exit the vessel through the first exit opening;
the second attendant, substantially simultaneously, directing the third and fourth queues to advance toward and exit the vessel through the second exit opening; and
repeating the method with respect to passengers seated in subsequent groups of rows until all passengers have evacuated the vessel, wherein
each row forming the first group of rows is spaced apart from the other rows forming the first group of rows by at least one row of a group of rows different from the first group of rows;
each row forming the second group of rows is spaced apart from the other rows forming the second group of rows by at least one row of a group of rows different from the second group of rows; and
each row of the vessel forms at least a portion of one group of rows.

11. A method of unloading passengers from a vessel having at least a plurality of columns of passenger resting positions and a plurality of rows of passenger resting positions, in which passengers rest while the vessel travels, at least one exit opening, and at least one aisle extending adjacent the plurality of rows to the exit opening, the method comprising:
maintaining all passengers in their respective resting positions until the vessel ceases motion;
directing a first group of passengers resting in a first group of rows and having belongings located between the exit opening and a first threshold row, to enter the aisle, retrieve their belongings and form a first queue prepared to advance toward the exit opening, each row of the first group of rows being spaced apart from the other rows of the first group of rows by at least one row of a group of rows different from the first group of rows;
directing the passengers in the first queue to advance toward and exit the vessel through the exit opening;
directing at least a second group of passengers resting in at least a second group of rows and having belongings located between the exit opening and a second threshold row, to enter the aisle, retrieve their belongings and form a second queue, each row of the at least second group of rows being spaced apart from the other rows of the at least second group of rows by at least one row of a group of rows different from the second group of rows;
directing the passengers in the second queue to advance toward and exit the vessel through the exit opening;
directing a last group of passengers resting in one of the first and at least second groups of rows and having belongings located in a row longitudinally spaced from the threshold row in a direction opposite the direction toward which the exit opening is located, to enter the aisle, retrieve their belongings and form a last queue; and
directing the passengers in the last queue to advance toward and exit the vessel through the exit opening.

12. A method of unloading passengers from a vessel having at least two columns of passenger resting positions and a plurality of rows of passenger resting positions, in which passengers rest while the vessel travels, at least one exit opening, and at least one aisle extending adjacent at least one column to the exit opening, the method comprising:
maintaining all passengers in their respective resting positions until the vessel ceases motion;
directing a first group of passengers resting in a first column positioned adjacent the aisle to retrieve their belongings, enter the aisle and form a first queue prepared to advance toward the exit opening;
directing the passengers in the first queue to advance toward and exit the vessel through the exit opening;
directing at least a second group of passengers resting in a second column positioned adjacent at least one of the aisle, the first column, and a lateral end of the vessel, to retrieve their belongings, enter the aisle and form a second queue prepared to advance toward the exit opening; and
directing the passengers in the second queue to advance toward and exit the vessel through the exit opening.

13. The method of claim 12 wherein the aisle is interposed between two columns of passenger resting positions, and the vessel comprises more than one column positioned between the aisle and respective first and second lateral ends of the vessel, the method further comprising:
forming the first group of passengers from the passengers resting in first and second columns, positioned immediately adjacent the aisle;
forming the at least second group of passengers from the passengers resting in a third column immediately adjacent the first column, and passengers resting in a fourth column immediately adjacent the second column.

14. A method of unloading passengers from a vessel having a plurality of passenger resting positions, in which passengers rest while the vessel travels, at least one exit opening, and at least one aisle extending toward the exit opening, the method comprising:
maintaining all passengers in their respective resting positions until the vessel ceases motion;
grouping all passengers into a plurality of groups that include a first group, a second group, and a third group;
instructing the first group of passengers to gather their belongings and enter the aisle while instructing the second and third groups of passengers to either remain in their passenger resting positions or to stay out of the aisle;
instructing the first group of passengers to advance toward and exit the vessel through the exit opening;
instructing the second group of passengers to gather their belongings and enter the aisle while instructing the third group of passengers to either remain in their passenger resting positions or stay out of the aisle;
instructing the second group of passengers to advance toward and exit the vessel through the exit opening;
instructing the third group of passengers to gather their belongings and enter the aisle; and
instructing the third group of passengers to advance toward and exit the vessel through the exit opening.

15. The method of claim 14 wherein grouping the passengers into the plurality of groups is based on the location of the passengers' resting positions.

16. The method of claim 14 wherein grouping the passengers into the plurality of groups is based on a travel status of the passengers.

17. The method of claim 16 wherein the travel status includes at least one of passengers having a connecting flight to catch, passengers traveling with children or an elderly companion, passengers having difficult to manage belongings, passengers with their belongings stored remotely with respect to their resting position, and passengers desiring to exit the vessel with a companion.

18. The method of claim 14 wherein instructing each of the plurality of groups to gather their belongings and enter the aisle includes instructing the passengers of the respective groups to remain in their passenger resting positions and not enter the aisle with their associated group if they desire to exit the vessel at a time subsequent to a time during which their associated group enters the aisle and exits the vessel or at a time after all of the plurality of groups have exited the vessel.

19. The method of claim 18 wherein instructing the first and second groups to gather their belongings and enter the aisle includes instructing the passengers of the respective groups, to remain in their passenger resting position and not enter the aisle with their associated group if they desire to exit the vessel with a companion who is associated with a different group, and to gather their belongings and enter the aisle with their companion when the different group is instructed to gather their belongings and enter the aisle or after all of the plurality of groups have exited the vessel.
